(19) United States
(12) Patent Application Publication
(10) Pub. No.: US 2003/0206314 A1
(43) Pub. Date: Nov. 6, 2003

(54) Workflow management device, facsimile machine, and communication device

(75) Inventor: Yoshifumi Tanimoto, Osaka (JP)

Correspondence Address: ARMSTRONG,WESTERMAN & HATTORI, LLP, 1725 K STREET, NW, SUITE 1000, WASHINGTON, DC, 20006, US

(73) Assignee: MURATA KIKAI KABUSHIKI KAISHA, Kyoto-shi (JP)

(21) Appl. No.: 10/426,699

(22) Filed: May 1, 2003

(30) Foreign Application Priority Data
May 1, 2002 (JP) 2002-130016

(51) Int. Cl. G06F 15/00; G06F 17/00; G06F 11/30; G06F 15/16

(52) U.S. Cl. 358/1.15; 707/10; 709/201

(57) ABSTRACT

To provide a workflow management device which can determine a workflow according to the content of information, and various devices which are an application of such a workflow management device. When data that is the subject of the processing operation is being sent, a first processing unit receives the data, and notifies an operator of the reception of the data via a notification unit. The operator confirms the content of the received data or other information, and instructs a workflow required to be carried out on the data in the second processing unit and afterward. The first processing unit carries out a first processing operation on the received data. When the instruction of the workflow by the operator and the first processing operation are completed, the second processing unit starts to execute the instructed workflow which is required to be carried out in the second processing operation and afterward.

### FIELD OF THE INVENTION

The present invention relates to workflow technology and an application of the workflow technology for processing work by carrying out processing in sequence.

### DESCRIPTION OF THE RELATED ART

Generally, when working in an office or the like, a document is exchanged between persons in charge, and each of the persons in charge executes a processing operation. Workflow technology is technology to manage the flow of the work similar to the aforementioned work by a computer system, and to process the work. In general, when managing the work by the workflow technology, the flow of work (workflow) is uniform. At the time when information is generated, the workflow of the information is determined. Then, in accordance with the determined workflow, a processing operation is carried out in sequence, and a series of work steps is carried out.

However, there are cases when the workflow cannot be determined automatically at a time immediately after the generation of the information. For example, when receiving image data from a remote device by a facsimile server or the like, it is necessary to reference the content of the image data, and then to determine a subsequent processing operation according to the content of the image data. However, there was the problem that the conventional workflow technology could not deal with the above-described case.

### SUMMARY OF THE INVENTION

The present invention was made with consideration to the above-described circumstance. An advantage of the present invention is the provision of a workflow management device which can determine workflow according to the content of the information, and various devices which are applied from the workflow management device.

To achieve the above-described advantage, an embodiment of the workflow management device of the present invention includes a reception unit, a first processing unit, a notification unit, an instruction accepting unit, and a second processing unit. The reception unit receives data. The first processing unit executes a processing operation for reception when receiving the data. The notification unit notifies to an operator of at least the presence of the data that is the subject of the processing operation. The instruction accepting unit accepts an instruction from the operator. The second processing unit starts to execute the next processing operation after the processing operation for reception by the first processing unit, in accordance with the instruction accepted by the instruction accepting unit.

As described above, the execution of the subsequent processing operations (workflow) starts in accordance with the instruction of the operator. Therefore, the operator can reference the content of the data, and then determine the workflow according to the content. Thus, optimum workflow can be executed on the data that is the subject of the processing operations.

Further, with various items of information of when receiving the data as a condition, the first processing unit can select the processing operation for reception to be executed to the data. Moreover, the second processing unit can start to execute a processing operation which is selected in accordance with the instruction from a plurality of subsequent processing operations.

The above-described workflow management device can be applied to various devices. For example, the workflow management device can be applied to a facsimile machine. In this case, the facsimile machine can include a communication unit, an instruction unit, and a control unit. The communication unit carries out a facsimile communication. The instruction unit carries out an instruction by an operator. The control unit starts to execute a subsequent processing operation in accordance with the instruction from the instruction unit after executing the processing operation for reception when receiving the image data by the communication unit. Accordingly, the processing operations subsequent to the processing operation for reception can be determined in accordance with the content of the image data received by the facsimile.

In addition, the above-described workflow management device can be applied to a communication device. In this case, the communication device can include a communication unit, an instruction unit, and a control unit. The communication unit transfers and receives information through a data exchanging network. The instruction unit carries out an instruction by an operator. The control unit starts to execute a subsequent processing operations in accordance with the instruction from the instruction unit after executing the processing operation for reception when receiving the information by the communication unit. Also in the case of the communication device, the processing operations subsequent to the processing operation for reception can be determined in accordance with the content of the information received through the data exchanging network.

### BRIEF DESCRIPTION OF THE DRAWINGS

FIG. 1 is a block diagram showing an embodiment of a workflow management device of the present invention.

FIG. 2A through FIG. 2C are views for describing examples of flow tables 5.

FIG. 3 is a flowchart showing an example operation of an embodiment of the workflow management device the present invention.

FIG. 4 is a flowchart showing another example operation of an embodiment of the workflow management device of the present invention.

FIG. 5 is a block diagram showing an embodiment of a facsimile machine of the present invention.

### DETAILED DESCRIPTION OF THE PREFERRED EMBODIMENTS

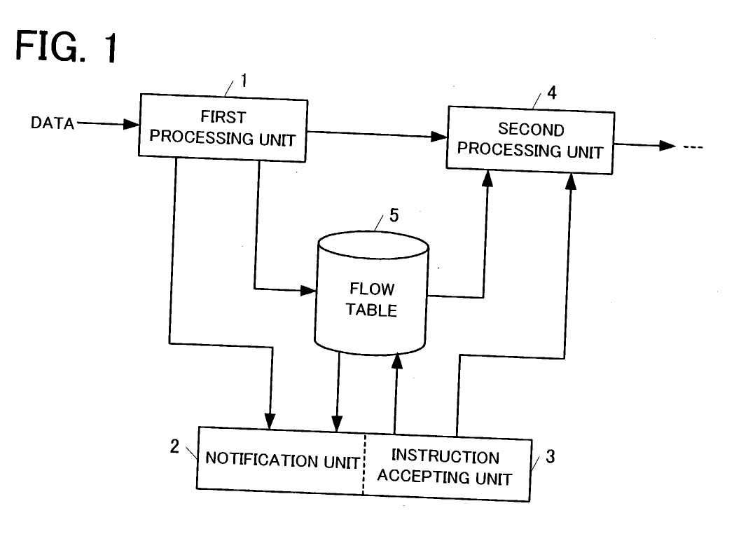

FIG. 1 is a block diagram showing an embodiment of a workflow management device of the present invention. In the drawing, the reference number 1 is a first processing unit, 2 is a notification unit, 3 is an instruction accepting unit, 4 is a second processing unit, and 5 is a flow table.

The first processing unit 1 executes a processing operation for reception when receiving data which is the subject of the processing operation by a workflow. At this time, the first processing unit 1 notifies the notification unit 2 of the fact that the data is received. Further, the execution of the first processing operation by the first processing unit 1 can be suspended until the workflow to be carried out after the second processing unit 4 by the instruction accepting unit 3 is determined. Moreover, even if the workflow to be carried out after the second processing unit 4 is not determined, the processing operation in the first processing unit 1 can be carried out. Alternatively, the two types of processing operations can be presented as an option.

The data that is the subject of the processing operation can be text data, image data, voice data, or various other data. The processing operation for reception is not limited to some changes or conversions which are carried out on the actual received data. For example, the processing for reception includes saving, printing, forwarding, or displaying the received data, fetching or updating other data, or generating a history of a fact of the reception of the data, or displaying the fact of the reception. The processing operation for reception indicates a variety of processing operations to be carried out at the time of reception in a broad sense. Moreover, the processing operation for reception can include the processing operation to be carried out by the operator, in addition to the processing operation to be carried out automatically. In addition, the processing operation can be executed on the received data uniformly, or with various items of information as the condition obtained when receiving the data, the processing operation can be selected.

The processing result of the first processing unit 1 is transferred to the second processing unit 4. Moreover, the processing result can be also provided to the notification unit 2. In addition, the data received by the first processing unit 1, information obtained during reception, or the like, can be provided to be referenced from the notification unit 2. Furthermore, in this example, when receiving data, the first processing unit 1 registers a record of the data to the flow table 5. Then, at the completion of the first processing operation, the first processing unit 1 registers in the record the fact that the processing operation in the first processing unit 1 is completed.

The notification unit 2 notifies an operator that there is at least the data that is the subject of the processing operation. Although the notification method can be any method, here, as an example, the notification method is displaying. The data received by the first processing unit 1, the processing result, and other various items of information obtained during reception can be referenced by an operation unit or the like (not shown in the drawings). Moreover, the flow table 5 can be referenced.

The instruction accepting unit 3 accepts an instruction of a workflow carried out by the operator to the second processing unit 4. Notification of the accepted instruction is sent to the second processing unit 4. The notified instruction to be sent to the second processing unit 4 can be an instruction to start the workflow, the specific content of the workflow, or when a plurality of workflows are defined in advance, an instruction to select which one of the plurality of workflows. In this example, an instruction to the subsequent workflow is carried out by registering at the flow table 5. In the drawing, it is shown notifying the start of the workflow to the second processing unit 4.

The second processing unit 4 determines the subsequent workflow, and starts to execute the workflow in accordance with the instruction received from the instruction accepting unit 3. Of course, the subsequent workflow is started after the processing operation in the first processing unit 1 is carried out. In this case, when the second processing operation is started by a presence of a part of the processing result in the first processing unit 1, the processing operation of the first processing unit 1 and the processing operation of the second processing unit 4 and afterward can be carried out at the same time.

When determining the workflow, in the case that a plurality of workflows are defined in advance, any one of the plurality of workflows is selected in accordance with an instruction, and execution of the selected workflow is started. In this example, the second processing unit 4 receives an instruction to start the workflow from the instruction accepting unit 3, and execution of the workflow registered in the flow table 5 is started.

The processing operation to be carried out by the second processing unit 4 can be any processing operation, and can be similar to the processing operation carried out by the first processing unit 1. That is, the processing operation to be carried out by the second processing unit 4 includes some changing or converting to be carried out on the data, and also, saving, printing, forwarding, or displaying of the data, fetching or updating other data, generating new data, notifying, and other various processing operations. Moreover, the processing operation to be carried out by the second processing unit 4 can also include a processing operation to be carried out by an operator, in addition to the processing operation carried out automatically. It is not necessary for the workflow, which has begun execution, to be completed in the second processing unit 4. The processing result in the second processing unit 4 can be transferred further to another processing unit, and the other processing unit can execute further processing operations.

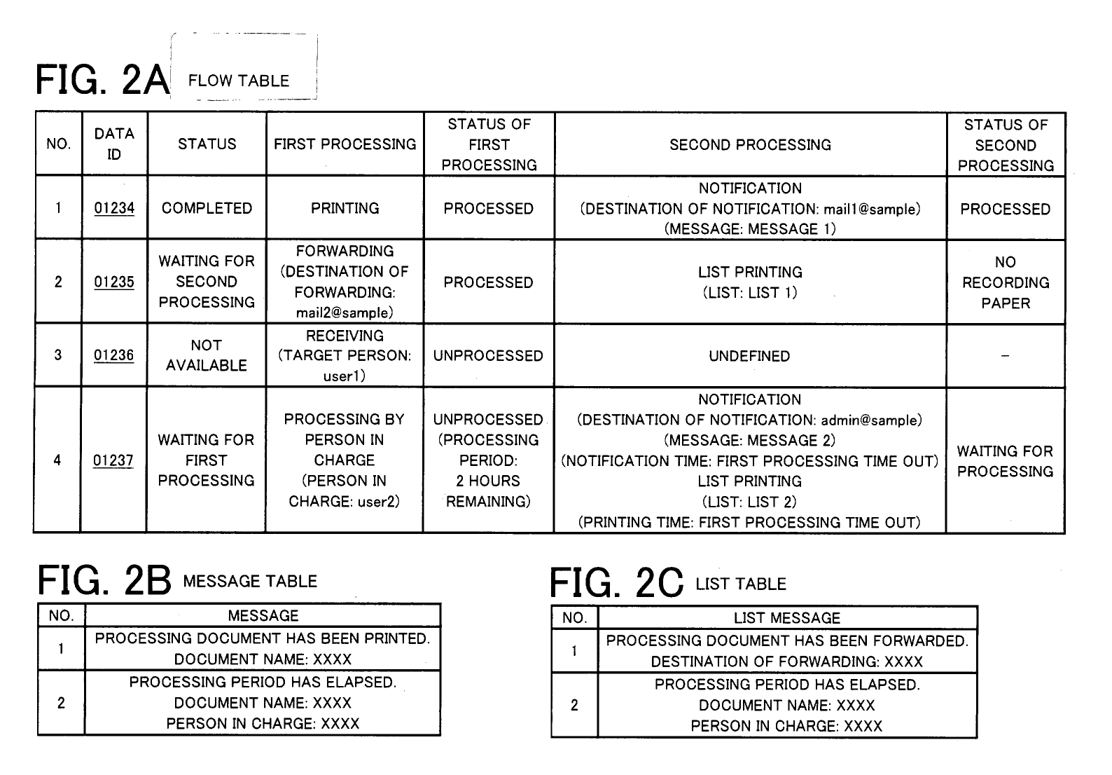

The workflow, a status or the like for each of the data is registered in the flow table 5. FIG. 2A through FIG. 2C are views which describe an example of the flow table 5. In this example, a message table shown in FIG. 2B, and a list table shown in FIG. 2C are used in a combination with the flow table shown in FIG. 2A. The message table registers a message, which is to be notified, as a format sentence in advance such that the message can be shared. The list table registers sentences of a list or the like, which is to be recorded and output, as a format sentence in advance such that the list can be shared. Moreover, the flow table 5 can be formed without using the message table, the list table, or the like.

In the example of the flow table 5 shown in FIG. 2A, each record has fields such as “Number (No.)”, “data ID”, “status”, “first processing operation”, “status of first processing operation”, “second processing operation”, “status of second processing operation”, etc.

The data ID is an ID for specifying the data that is the subject of the processing operation. In the example shown in FIG. 2A, consecutive numbers are applied. The consecutive numbers are linked to the actual data, and based on the data ID, the data itself can be referenced.

The “status” field shows the status of the data. For example, the first record stores “completed”, which shows that all processing operations has been completed. “Waiting for second processing operation” in the next record shows the status in which the completion of the processing operation of the second processing unit 4 and afterward has not yet completed. Here, the status includes the case when it is before the second processing unit 4 starts processing operation, and the case when the second processing unit 4 is executing the processing operation. These two cases can be shown separately. “Not available” in the third record shows, for example, a case when the processing operation in the first processing unit 1 is not completed. In addition, there are cases when “not available” shows the status in which the processing operation of the first processing unit 1 is suspended due to the workflow for the second processing operation and afterward being undefined. Furthermore, “waiting for first processing operation” in the next record shows that the processing operation in the first processing unit 1 is being executed.

In the “first processing operation” field, the content of the processing operation to be carried out by the first processing unit 1, a person in charge of the processing operation, or the like are registered. As described above, in the first processing unit 1, the processing operation can be selected in accordance with information obtained when receiving the data, and the content of the selected processing operation is described in the “first processing operation” field. In the case of “printing”, the data is printed out. In the case of “forwarding”, the data is forwarded to a “destination of forwarding”. In the case of “receiving”, the data addressed to “target person: user1” is being received. Furthermore, in the case of “processing by person in charge”, the processing of the data is carried out by the “person in charge: user2”.

In the “status of first processing operation” field, the fact of whether or not the processing operation in the first processing unit 1 is completed is registered. The first two records are already “processed”, and the third record is “unprocessed”. The fourth record is also “unprocessed”, but the flow table shows that the status of the “processing period” of the first processing operation is “2 hours remaining”. As described above, a processing period can be set for the processing operation. In this example, the processing operation for after an elapse of the processing period is to be set again by the first processing unit 1. However, the processing operation for after an elapse of the prescribed period can be registered in the “first processing operation” field in advance.

In the “second processing operation” field, the content of the processing operation to be executed by the second processing unit 4, or the entire workflow for the second processing unit 4 and afterward can be registered. For the content of the “second processing operation” field, the content of an instruction received at the instruction accepting unit 3 from the operator is registered. The content of the processing operation can be any of the types of content described above.

In this example, when carrying out a “notification” processing operation of the first record, “destination of notification: mail1@sample” and “message1” as the message are designated. That is, for the content of the message to be notified, a first message stored in the message table as shown in FIG. 2B (“Processing document has been printed. Document Name: XXXX”) is notified. This message is a message showing that printing is carried out in the first processing operation.

For the content of “list printing” in the second record, “list 1” is designated as the “list”, and the content of a first list stored in the list table as shown in FIG. 2C (“Processing document has been forwarded. Destination of Forwarding: XXXX”) is output. This message is a list message showing that forwarding is carried out in the first processing operation.

“Undefined” in the third record shows that the workflow, which the second processing unit 4 starts to execute, is not determined due to the processing operation in the first processing unit 1 being not completed.

The fourth record designates several processing operations. In addition, the fourth record designates time. In this example, it is designated as “first processing operation time out”. That is, it is designated to carry out the notification and the list printing automatically when the processing period elapses without the processing operation in the first processing unit 1 being carried out. As described above, it can be designated for the workflow to be carried out automatically.

In the “status of second processing operation” field, the status of the second processing unit 4 and after is registered. For example, the information showing the status such as “processed”, “waiting for processing operation”, “unprocessed”, or the like are registered. “No recording paper” in the second record shows that, although list printing has been attempted, since there was no recording paper, it is in an error state. As described above, the content of the error can be included in the “status of second processing operation” field.

In such a flow table 5, one record is generated when receiving the data. In this case, the content of the processing operation to be carried out by the first processing unit 1 is registered to the “first processing operation” field from various items of information obtained when receiving the data. Moreover, in the “second processing operation” field, the information is registered according to an instruction accepted from an operator at the instruction accepting unit 3. Furthermore, the “status” field is rewritten according to start, completion or the like of the processing operation in the first processing unit 1 and the second processing unit 4. The flow table 5 that is obtained as described above shows the processing operation required to be carried out and the progress of the processing operations for all data. The flow table 5 can be used for management or the like of the workflow.

The flow table 5 shown in FIG. 2A is an example, and any information can be registered in the flow table 5. For example, when there is a processing operation after the second processing unit 4, the content or the status of third processing operation, fourth processing operation and so fourth can be registered.

Further, in the configuration shown in FIG. 1, the workflow is managed by using the flow table 5. However, the present invention is not limited to this example, and without using the flow table 5, the workflow can progress by transferring and receiving the content of the data or the processing operation directly. Alternatively, the notification from the first processing unit 1 to the notification unit 2, or the instruction from the instruction accepting unit 3 to the second processing unit 4 can be carried out via the flow table 5. In this case, it can be constructed such that each unit operates by detecting the change in the flow table 5.

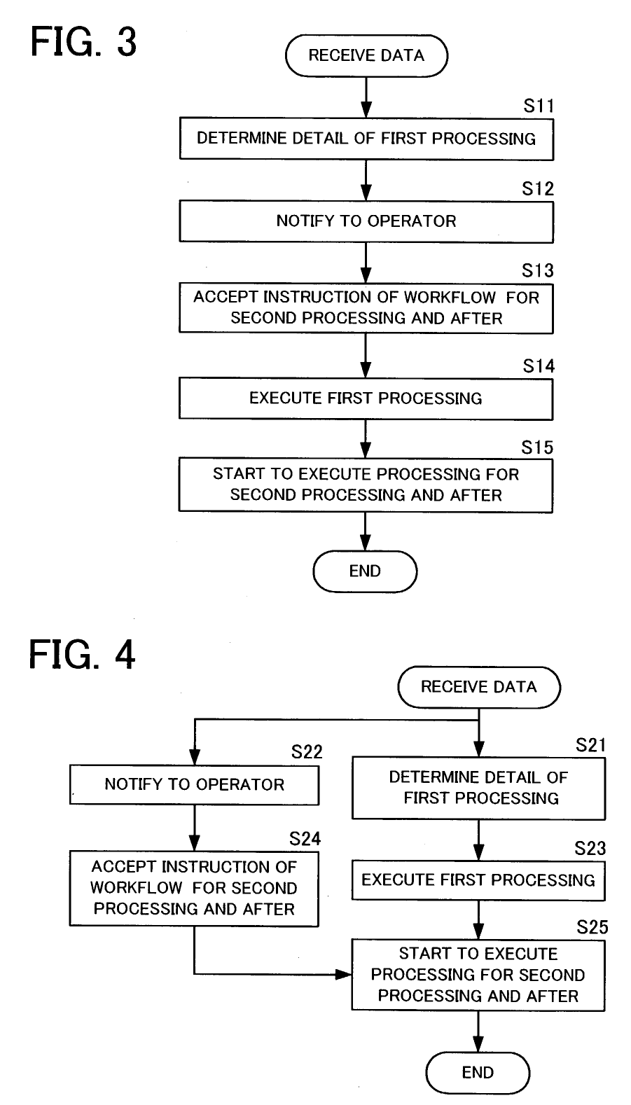

FIG. 3 is a flowchart showing an example of an operation of a workflow management device according to an embodiment of the present invention. When the first processing unit 1 receives the data that is the subject of processing operation, in S11, from the information obtained when receiving the data, the details of the first processing operation on the obtained information are determined. In other words, the specific processing to be carried out for the first processing operation is determined. In S12, the fact that the data has been received is notified to the notification unit 2, and an arrival of the data to be processed is notified to the operator from the notification unit 2. Further, the processing operation of S11 and the processing operation of S12 can be carried out in either order.

The operator references the content of the data or other information accordingly. Then, in S13, the workflow to be carried out in the second processing unit 4 and afterward is determined, and an instruction of the workflow and an instruction to start the execution of the workflow are carried out. The instructions are accepted by the instruction accepting unit 3, and the instructions are notified to the second processing unit 4.

By taking the determination of workflow for the second processing unit 4 and afterward and the instruction to start the execution as an opportunity, in S14, the first processing operation on the data is started at the first processing unit 1. After the end of the first processing operation in the first processing unit 1, the second processing unit 4 starts to execute the workflow to be carried out in the second processing unit 4 and afterward, which has been instructed from the instruction accepting unit 3.

FIG. 4 is a flowchart showing another example of an operation of the workflow management device according to an embodiment of the present invention. In the example shown in FIG. 3, the first processing operation in the first processing unit 1 is not started unless the operator determines the workflow to be carried out in the second processing unit 4 and afterward. In the example shown in FIG. 4, the operation of the first processing unit 1, and the determination of the workflow to be carried out in the second processing unit 4 and afterward are carried out at the same time.

When the first processing unit 1 receives the data that is the subject of processing, in S21, from the information obtained when receiving the data, the details of the first processing operation for the obtained information is determined. Then, in S22, the fact that the data has been received is notified to the notification unit 2, and the arrival of the data required to be processed is notified to the operator from the notification unit 2. Further, the processing of S21 and the processing of S22 can be carried out in either order. In S23, the first processing unit 1 executes the first processing operation in accordance with the processing content determined in S21.

When the operator knows from the notification in S22 that the data has been received, the operator references the content of the data or other information accordingly. In S24, the workflow to be carried out in the second processing unit 4 and afterward is determined, and the instruction of the workflow and the instruction to start the execution of the workflow are carried out. In this case, for example, the instructions and the first processing operation in the first processing unit 1 can be carried out at the same time. Moreover, the instructions can be carried out after the processing operation of the first processing unit 1 has been completed. When the processing operation of the first processing unit 1 is completed, by referencing the processing results in the first processing unit 1, the workflow to be carried out in the second processing unit 4 and afterward can be determined. The instruction accepting unit 3 accepts the instruction of the operator, and notifies the instruction to the second processing unit 4.

When the first processing operation in the first processing unit 1 is completed, and the instruction by the operator is carried out, in S25, the second processing unit 4 starts to execute the workflow which is instructed from the instruction accepting unit 3 and which is required to be carried out in the second processing unit 4 and afterward.

As described above, in either one of the operation examples, even when the workflow cannot be determined just by receiving the data, for example, the operator can reference the content of the data, and carry out an instruction for the workflow of the second processing operation and afterward. Accordingly, optimum processing can be carried out on the received data. Of course, even when not receiving an instruction of the operator, if the subsequent workflow can be determined at the time when receiving the data, the workflow can be determined and executed automatically as in the conventional device.

Moreover, for example, the above-described two operation examples can be combined, and among all parts of the first processing operation in the first processing unit 1, some parts can be carried out at the reception of the data, and the remaining parts can be carried out after the operator determines the workflow to be carried out in the second processing unit 4 and afterward. Furthermore, in this example, the operator is notified at the reception of the data. However, the operator can be notified after the first processing operation in the first processing unit 1 has been completed, and then the operator can determine the workflow to be executed in the second processing unit 4 and afterward.

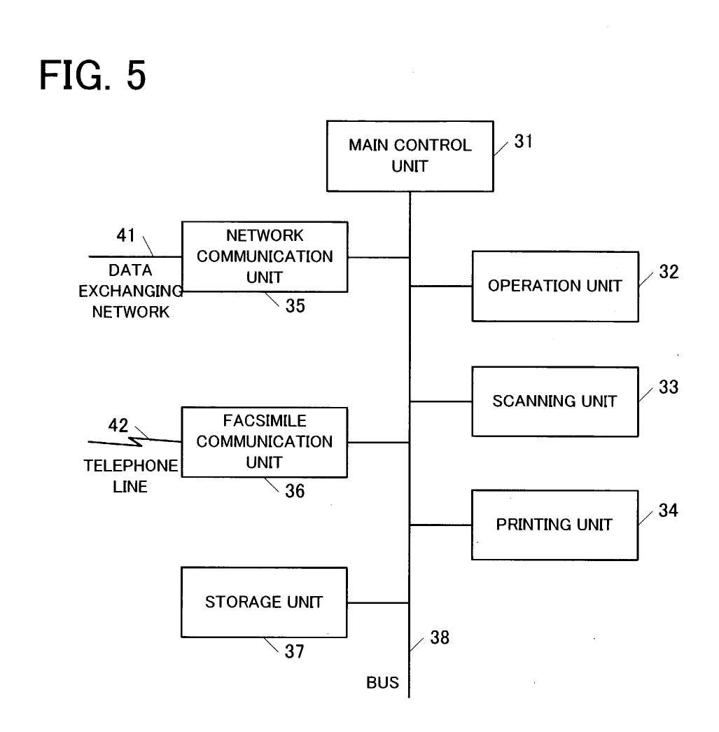

FIG. 5 is a block diagram showing a facsimile machine according to an embodiment of the present invention. In FIG. 5, the reference number 31 is a main control unit, 32 is an operation unit, 33 is a scanning unit, 34 is a printing unit, 35 is a network communication unit, 36 is a facsimile communication unit, 37 is a storage unit, 38 is a bus, 41 is a data exchanging network, and 42 is a telephone line. The facsimile machine shown in FIG. 5 includes a function for carrying out G3 or G4 facsimile communication through the telephone line 42. In addition, the facsimile machine includes a function for exchanging an Internet facsimile, an electronic mail, or other data through the data exchanging network 41.

The main control unit 31 controls the entire facsimile machine, and operates each unit to realize a facsimile communication function, a data exchanging function of data such as the electronic mail, a copy function, a printer function, a scanner function or the like. In particular, the main control unit 31 includes a function as the workflow management device of the present invention.

The operation unit 32 includes a display unit, an input unit or the like. The operation unit 32 displays on the display unit, various items of information such as a message for the operator, a message indicating the status of the facsimile machine, an operation guidance or the like. In addition, from the input unit, the operator can carry out various settings or instructions. In particular, the operation unit 32 carries out notification (displaying, etc.) to the operator, and accepts an input of the instruction by the operator as a part of the instruction accepting unit 3.

The scanning unit 33 scans an image of an original when transmitting an image by facsimile or electronic mail, at the time of the copy function, or at the time of the scanner function. Moreover, the printing unit 34 forms on recording paper, information received by the facsimile or the electronic mail by the image receiving function, an image scanned at the scanning unit 33 by the copy function, an information received via the network communication unit 35 by the printer function, or other system information. Further, the facsimile machine can include either one of the scanning unit 33 and the printing unit 34, or it can include neither one.

The network communication unit 35 is connected to the data exchanging network 41, such as a Local Area Network (LAN) or the Internet. The network communication unit 35 carries out a transmission and a reception of the electronic mail or other data. Moreover, the facsimile communication unit 36 carries out G3 or G4 facsimile communication with other facsimile machines by using the telephone line 42, such as a public line or a private line.

The storage unit 37 stores a program which defines the operation of the main control unit 31, data which must be saved, image data to be transmitted and received, image data scanned by the scanning unit 33, image data to be printed by the printing unit 34, image data being processed, or the like. For example, the storage unit 37 can store the flow table 5 shown in FIG. 1.

A bus 38 connects the main control unit 31, the operation unit 32, the scanning unit 33, the printing unit 34, the network communication unit 35, the facsimile communication unit 36, the storage unit 37 or the like to one another, to permit the data to be exchanged between each of the units. Of course, various devices or various interfaces such as a remote storage device can be connected to the bus 38 in addition to the above-mentioned units.

Next, an example of an operation in the facsimile machine according to an embodiment of the present invention will be described. In particular, the management of the workflow will be described. As an example, the example of the operation will be described with reference to FIG. 4. Of course, the example of the operation shown in FIG. 3 or other variations are possible. Reception of the data that is the subject of the processing operation generates by receiving a facsimile via the telephone line 42 by the facsimile communication unit 36, by receiving electronic mail or the like via the data exchanging network 41 by the network communication unit 35, or by scanning an image of an original by the scanning unit 33.

Then, the main control unit 31 executes the first processing operation on the data. For the first processing operation, various processing operations can be carried out. For example, storing in the storage unit 37, displaying on the operation unit 32 (displaying data, displaying message, etc.), printing out by the printing unit 34, forwarding using the facsimile communication unit 36 or the network communication unit 35, can be carried out. These processing operations can be selected automatically according to the information that can be obtained at the time the data that is the subject of the processing operation generates. Of course, the first processing operation is not limited to one processing operation, and a plurality of processing operations can be carried out.

For the information that can be obtained at the time the data generates, for example, in the case of the facsimile reception, there is a telephone number of the calling station notified from an exchanger, a subaddress or a name of the calling station obtained from the facsimile communication protocol signal, or other various items of information. In the case of receiving electronic mail, information about the calling station can be obtained from the electronic mail protocol or a message of the electronic mail, and various items of information can be obtained from a header part or a main text part of the electronic mail. Furthermore, when scanning by the scanning unit 33, the information can be obtained from the operation unit 32 by the operation of the operator.

Moreover, the operator is notified of the generation of the data that is the subject of the processing operation. For example, the operator can be notified of the generation from a display on the display unit, or an activation of the buzzer or the like. Alternatively, the operator of another network device can be notified of the generation from the network communication unit 35 through the data exchanging network 41. The operator references the data that is the subject of the processing operation or other information. Then, the operator determines and instructs the workflow for the second processing operation and afterward. For example, the instruction can be input from the input unit of the operation unit 32, or the information input by the operator at another network device can be received at the network communication unit 35 through the data exchanging network 41.

For example, when considering a case of the facsimile reception, there are many cases when the handling of the received image data cannot be determined unless judging a destination name, content of the writing or the like described in the received image data. In the present invention, the operator references the received image data, and determines the subsequent handling of the received image data as the workflow. Accordingly, it becomes possible to carry out a processing operation on the received image data accurately.

Further, when determining the workflow for the second processing operation and afterward by the operator, a condition for the result of the first processing operation can be set. For example, the workflow for the second processing operation and afterward can be set in accordance with the condition such as whether the result of the first processing operation is a normal end or an abnormal end, information of a person who carried out the processing operation (if XXX processes/does not process, etc.), various items of information such as the time when the processing operation was carried out (if processing operation is carried out/not carried out between XX o'clock and YY o'clock, or before ZZ o'clock, etc.), or when an abnormality is generated or an unauthorized processing operation is carried out, in which part of the processing operation the abnormality generated or the unauthorized processing operation has been carried out. Moreover, when outputting some data in the second processing operation, various items of information items necessary for the output can be defined. For example, the content of the electronic mail to be forwarded and the address of the destination can be defined. In addition, in the case of the list printing, the content or the recording paper size, and in the case of the displaying, the content to be displayed and the display time can be defined.

Furthermore, when determining the workflow for the second processing operation and afterward from the operation unit 32 provided in the facsimile machine, there are cases when the operationality is not sufficient to carry out minute instruction. In such a case, the workflow for the second processing operation and afterward can be made as a group, and one or a plurality of groups can be registered in advance, and a group can be selected. For selecting the group, a group name or an identifier of the group can be used. As a specific example, an identifier of “group 1” can be applied to a second processing operation which is to transmit an electronic mail having a name of the operator who referenced the data and the main text of “referenced” to a mail address of “abc@abc.ab.cd” when there is a reference of the data. Moreover, an identifier of “group 2” can be applied to a second processing operation which is to record the name of operator who updated the data and “data updated” to log information, and to transmit an electronic mail having the name of the operator who updated the data and the main text of “updated” to mail addresses of “abc@abc.ab.cd”, “xyz@abc.ab.cd” when the data is updated. Then, the workflow for the second processing operation and afterward becomes capable of being set, for example, to register the group 1 under a condition of the facsimile communication and the transmitter terminal number 32345, or to register the group 2 under a condition of being scanned by the scanning unit 33.

When the first processing operation ends, and when receiving an instruction of the workflow for the second processing operation and afterward from the operator, the main control unit 31 starts to execute the instructed workflow for the second processing operation and afterward. For the processing to be executed in the second processing operation and afterward, there are displaying on the operation unit 32 (displaying of a data, displaying of a message, etc.), printing out by the printing unit 34 (printing out of a data, a list, etc.), forwarding using the facsimile communication unit 36 or the network communication unit 35, generating the data such as a log, updating the data, or other various processing operations. Further, the processing operation to be carried out is not limited to one of the processing operations, and several processing operations can be carried out at the same time or in order.

Moreover, a condition can be set such that for example, when no one referenced the data even after an elapse of one hour, a prescribed electronic mail message is transmitted to a prescribed mail address. Furthermore, when forwarding to another device, not only the data but the information relating to the workflow for the data can be forwarded, and the workflow can be continued at the destination of forwarding.

Further, the operator can determine the workflow for the second processing operation and afterward, after the end of the first processing operation. In this case, the workflow for the second processing operation and afterward can be determined by the operator possessing the result of the first processing operation, the information of the person who carried out the processing operation, various items of information such as the time when the processing operation was carried out, or when the abnormality is generated or an unauthorized processing operation is carried out, in which part of the processing operation the abnormality was generated or the unauthorized processing operation was carried out.

In the example shown in FIG. 5, an example of the facsimile machine which can carry out the facsimile communication was shown. However, the example shown in FIG. 5 can be formed as a communication device of the present invention by not providing the facsimile communication unit 36. The operation for the communication device is also the same as the above-described example for the facsimile machine.

What is claimed is:

1. A workflow management device comprising:
a receiving means for receiving data;
a first processing means for executing a processing operation for reception when receiving the data;
a notifying means for notifying an operator that there are data that is the subject of the processing operation;
an instruction accepting means for accepting an instruction from the operator; and
a second processing means for starting execution of the next processing operation after the processing operation by the first processing means in accordance with the instruction accepted by the instruction accepting means.

2. The workflow management device according to claim 1, wherein the second processing means starts executing a processing operation selected from a plurality of processing operations in accordance with the instruction.

3. The workflow management device according to claim 1, wherein the first processing means selects a processing operation to be carried out on the data with information of when receiving the data as a condition.

4. The workflow management device according to claim 1, wherein the receiving means is a facsimile receiving means, and the first processing means selects a processing operation to be carried out on the data with information of when receiving a facsimile as a condition.

5. The workflow management device according to claim 4, wherein the various items of information is a transmitter terminal number.

6. The workflow management device according to claim 4, wherein the various items of information is a Transmitting Subscriber Identification (TSI) signal or SUB address (SUB) signal included in a facsimile protocol signal.

7. The workflow management device according to claim 1, wherein the receiving means is an electronic mail receiving means, and the first processing means selects the processing operation to be carried out on the data with various items of information when receiving electronic mail as a condition.

8. The workflow management device according to claim 7, wherein the various items of information include an electronic mail protocol signal.

9. The workflow management device according to claim 7, wherein the various items of information include an electronic mail message.

10. The workflow management device according to claim 1, wherein the first processing means is to suspend the processing operation until an instruction of a processing operation for the second processing means and afterward is carried out by the instruction accepting means.

11. A facsimile machine comprising:
a facsimile communication unit which carries out a facsimile communication;
an instruction unit which is for an operator to carry out an instruction; and
a control unit which carries out a processing operation for reception, determines subsequent processing operation in accordance with an instruction from the instruction unit, and starts execution, when receiving image data by the facsimile communication unit.

12. A communication device comprising:
a communication unit which transmits and receives information through a data exchanging network;
an instruction unit which is for an operator to carry out an instruction; and
a control unit which carries out a processing operation for reception, determines a subsequent processing operation in accordance with an instruction from the instruction unit, and starts execution, when receiving an information by the communication unit.

13. A workflow management method comprising the steps of:
receiving data;
executing a first processing operation for reception when receiving data;
notifying an operator that there is data that is the subject of a processing operation;
accepting an instruction from the operator; and
starting to execute a second processing operation which is the processing operation subsequent to the first processing operation in accordance with the accepted instruction.

14. The workflow management method according to claim 13, wherein the second processing operation is selected from a plurality of processing operations in accordance with the instruction.

15. The workflow management method according to claim 13, wherein with various items of information of when receiving data is a condition, the first processing operation selects the processing to be executed to the data.

16. The workflow management method according to claim 13, wherein the first processing operation suspends processing until an instruction of the processing of the second processing operation and afterward is carried out by the accepted instruction.
